(19) United States
(12) Patent Application Publication
(10) Pub. No.: US 2024/0094011 A1
(43) Pub. Date: Mar. 21, 2024

(54) AUGMENTED-REALITY-BASED VEHICLE POSITIONING

(71) Applicant: International Business Machines Corporation, Armonk, NY (US)

(72) Inventors: Sarbajit K. Rakshit, Kolkata (IN); Shailendra Moyal, Pune (IN)

(73) Assignee: International Business Machines Corporation, Armonk, NY (US)

(21) Appl. No.: 17/949,423

(22) Filed: Sep. 21, 2022

(51) Int. Cl. G01C 21/34; G06Q 50/30

(52) U.S. Cl. CPC G01C 21/3407; G06Q 50/30

(57) ABSTRACT

A method for utilizing augmented reality for positioning vehicles is disclosed. In one embodiment, such a method enables a customer to visualize, by way of an augmented reality device, a desired position of a vehicle selected to arrive at a designated pickup spot. This may include visualizing, by way of the augmented reality device, the desired position within an environment surrounding the pickup spot. The desired position may include one or more of a location and orientation of the vehicle and may be selected to optimize loading of passengers and/or cargo into the vehicle. The method documents the desired position and communicates the desired position to a ride-hailing service to enable the vehicle to be placed in accordance with the desired position upon arriving at the designated pickup spot. A corresponding system and computer program product are also disclosed.

### BACKGROUND

### Field of the Invention

This invention relates to systems and methods for utilizing augmented reality for positioning vehicles scheduled to arrive at designated pickup spots.

### Background of the Invention

Ride-hailing services such as Uber, Lyft, Ola or the like enable customers to summon vehicles (typically with drivers) to provide a ride from one point to another. In most cases, this is accomplished through a ride-hailing application installed on a mobile device, such as a smartphone. In general, when a request for a vehicle is made, the ride-hailing application sends a customer's location to a nearby vehicle and driver who can decide if he or she would like to accept the ride. If the ride is accepted, the customer can typically see a location of the vehicle on the ride-hailing application as it moves in his or her direction. A time is typically provided to indicate how long it will take until the vehicle arrives. The ride-hailing application typically displays information about the ride, such as a plate number of the vehicle and/or name of the driver.

Although ride-hailing applications are useful to summon vehicles for rides from one point to another, they can be less useful or optimized when it comes to actually picking up a customer. For example, a vehicle that arrives in response to a request may approach the customer in a direction or at an orientation or location that is not convenient or even unsafe for the customer to get into the vehicle and/or load baggage or other items into the vehicle. If a customer is disabled, an arriving vehicle may not be conveniently oriented or positioned to enable the customer to get into the vehicle. This can make catching a ride more cumbersome, inconvenient, or unsafe than is necessary.

### SUMMARY

The invention has been developed in response to the present state of the art and, in particular, in response to the problems and needs in the art that have not yet been fully solved by currently available systems and methods. Accordingly, systems and methods have been developed for utilizing augmented reality for positioning vehicles and/or loading passengers or items therein. The features and advantages of the invention will become more fully apparent from the following description and appended claims, or may be learned by practice of the invention as set forth hereinafter.

Consistent with the foregoing, a method for utilizing augmented reality for positioning vehicles is disclosed. In one embodiment, such a method enables a customer (i.e., user) to visualize, by way of an augmented reality device, a desired position of a vehicle selected to arrive at a designated pickup spot. This may include visualizing, by way of the augmented reality device at or near a time of the booking the vehicle, the desired position of a specific and make and model of the vehicle within an environment surrounding the pickup spot. The desired position may include one or more of a location and orientation of the vehicle and may be selected to optimize loading of passengers and/or cargo (e.g., luggage) into the vehicle. The method documents the desired position and communicates the desired position to a ride-hailing service to enable the vehicle to be placed in accordance with the desired position upon arriving at the designated pickup spot.

A corresponding system and computer program product are also disclosed and claimed herein.

The claimed invention provides greater utility and optimization over known techniques for picking up a customer. For example, using the claimed invention, a vehicle that arrives in response to a request may be located or oriented in a way that is safer and more convenient for a customer to get into the vehicle and/or load baggage or other items into the vehicle. If a customer is disabled, an arriving vehicle may be more conveniently oriented or positioned to accommodate the customer's disability. This can make catching a ride with a ride-hailing service easier, safer, and more convenient.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a high-level block diagram showing one example of a computing system for use in implementing various methods in accordance with the invention;

FIG. 2 is a process flow diagram showing one embodiment of a method for utilizing augmented reality for positioning vehicles;

FIG. 3 is a process flow diagram showing additional steps of the method of FIG. 2 in the event multiple vehicles are involved;

FIG. 4 is a perspective view showing a vehicle arriving at a designated pickup spot without any position information;

FIG. 5 is a perspective view showing a vehicle arriving at a designated pickup spot using position information received from an augmented reality device; and

FIG. 6 is a perspective view showing multiple vehicles arriving at a designated pickup spot using position information received from an augmented reality device.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code associated with an augmented-reality-based positioning module 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

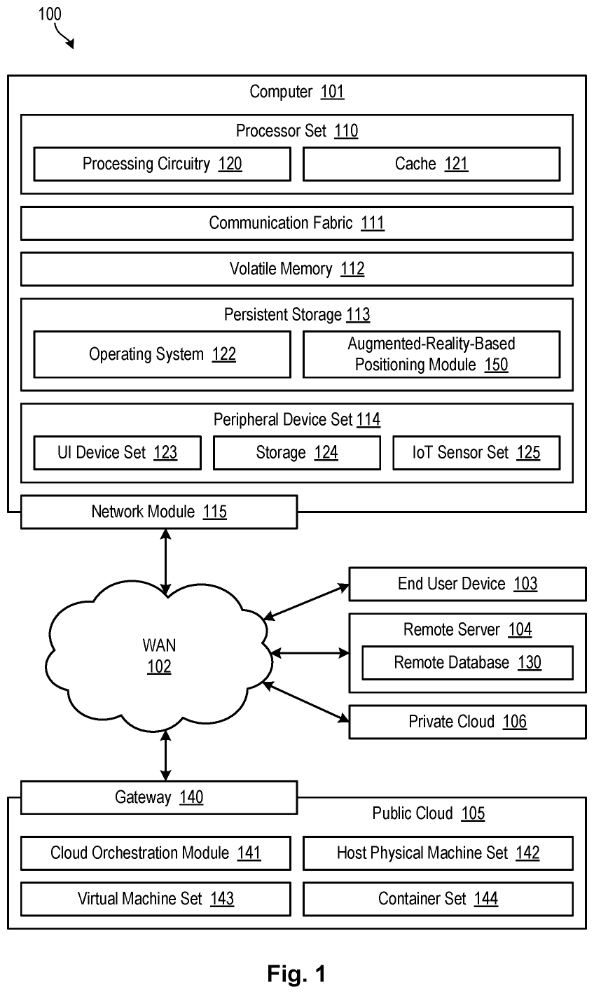

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

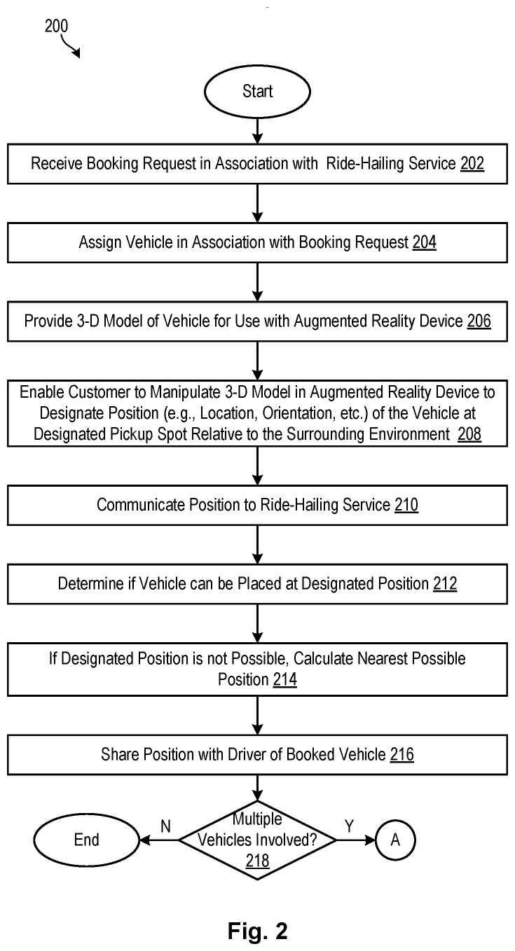

Referring to FIG. 2, as previously mentioned, ride-hailing services such as Uber, Lyft, Ola or the like may enable customers to summon vehicles to provide a ride from one point to another. In most cases, this is accomplished through a ride-hailing application installed on a mobile device, such as a smartphone. In general, when a request for a vehicle is made, the ride-hailing application sends a customer's location to a nearby vehicle and driver who can decide if he or she would like to accept the ride. If the ride is accepted, the customer can typically see a location of the vehicle on the ride-hailing application as it moves in his or her direction. A time is typically provided to indicate how long it will take until the vehicle arrives. The ride-hailing application typically displays information about the ride, such as a plate number of the vehicle and/or name of the driver.

Although ride-hailing applications are quite useful to summon vehicles for rides from one point to another, they can be less useful or optimized when it comes to actually picking up a customer. For example, a vehicle that arrives in response to a request may approach a customer in a direction or at an orientation or location that is not convenient for the customer to get into the vehicle and/or load baggage or other items into the vehicle. If a customer is disabled, an arriving vehicle may not be conveniently oriented or positioned to enable the customer to easily get into or out of the vehicle. This can make catching a ride more cumbersome, inconvenient, or unsafe than is necessary.

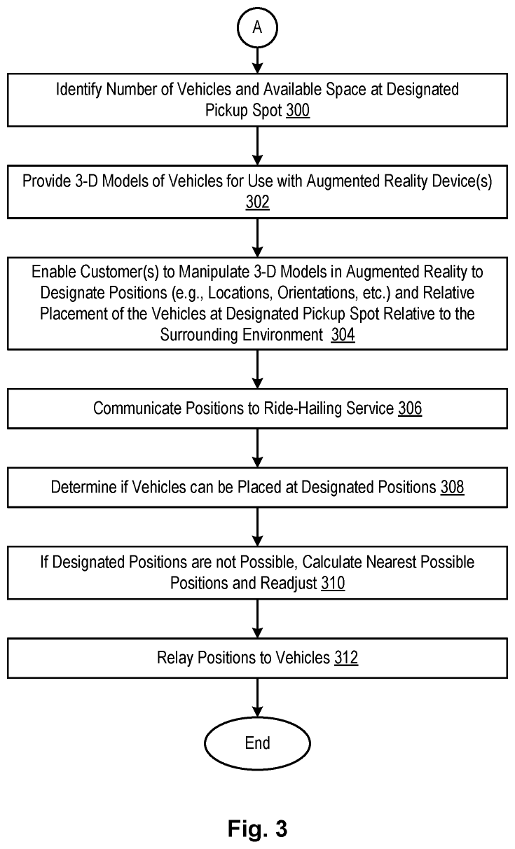

For example, FIG. 3 shows the arrival of a vehicle 400 at a designated pickup spot, in this example in front of a building 402. In the illustrated example, the vehicle 400 may arrive or park at a location that is inconvenient or non-ideal to the customer. For example, the car may arrive some distance from a door 404 or other location that would be most convenient to the customer to board the vehicle 400 and/or load cargo (e.g., luggage) into the vehicle 400. In some cases, a customer may have to traverse some distance to the vehicle 400 to either board or load luggage into the vehicle 400. In other cases (not shown), a customer may have to cross busy streets or traverse other obstacles (e.g., curbs, barriers, landscaping elements, etc.) or go around a building 402 to get to the vehicle 400. In some cases, this may present a safety hazard. In other cases, it may present a significant inconvenience, particularly if the customer has to transport luggage to the vehicle 400. If the customer is disabled or has significant infirmities, getting to the vehicle 400 may be very difficult if the vehicle 400 is poorly positioned.

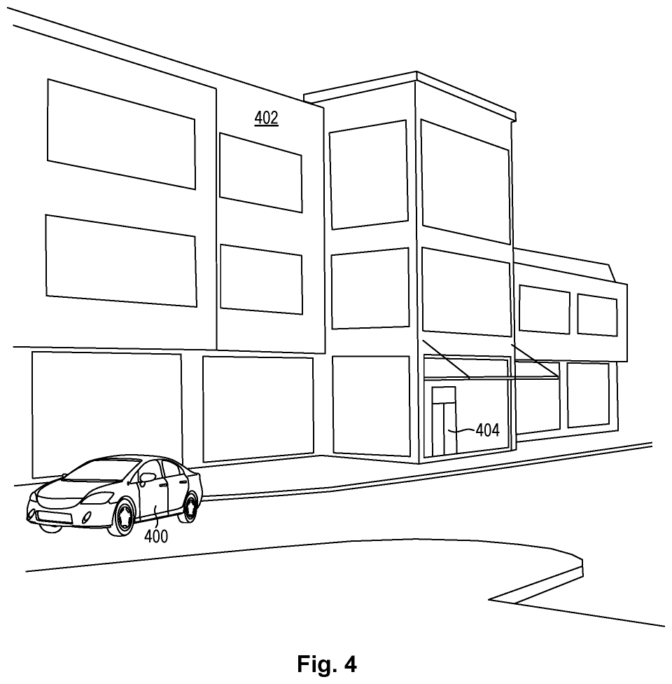

Referring to FIGS. 2 and 3, one embodiment of a method 200 for utilizing augmented reality for positioning a vehicle 400 is illustrated. Such a method 200 may address many of the issues or shortcomings described above with respect to retrieving a customer or luggage at a designated pickup spot. All or part of the method 200 may, in certain embodiments, be implemented by the augmented-reality-based positioning module 150 shown and described in association with FIG. 1. While referring to FIGS. 2 and 3, general reference is also made to FIGS. 4 through 6.

As shown in FIG. 2, in one embodiment, a method 200 in accordance with the invention may initially receive 202 a booking request in association with a ride-hailing service. The method 200, and more particularly the ride-hailing service, may then assign 204 a vehicle 400 to the customer in association with the booking request. In certain embodiments, assigning 204 the vehicle 400 may include providing 206 a 3-D model of the vehicle 400 to the customer for use by the customer in an augmented reality device (e.g., augmented reality glasses or headset, or an augmented reality display such as that used in a vehicle). For example, assigning 204 a vehicle 400 may include assigning 204 a specific make, model, and year of vehicle to pick up the customer. This make, model, and year may have associated therewith a specific 3-D model that reflects the external and potentially internal shape and dimensions of the vehicle.

The method 200 may enable 208 the customer to manipulate 208 (e.g., rotate, translate, etc.) the 3-D model in augmented reality to designate a position (e.g., location, orientation, etc.) of the vehicle at the designated pickup spot. For example, with the surrounding real-world environment (e.g., buildings, landscaping, roads, architectural elements, etc.) as the backdrop, the customer may rotate or translate the 3-D model of the vehicle 400 relative to the backdrop to show how the customer wants the vehicle 400 positioned when the vehicle 400 arrives at the designated pickup spot.

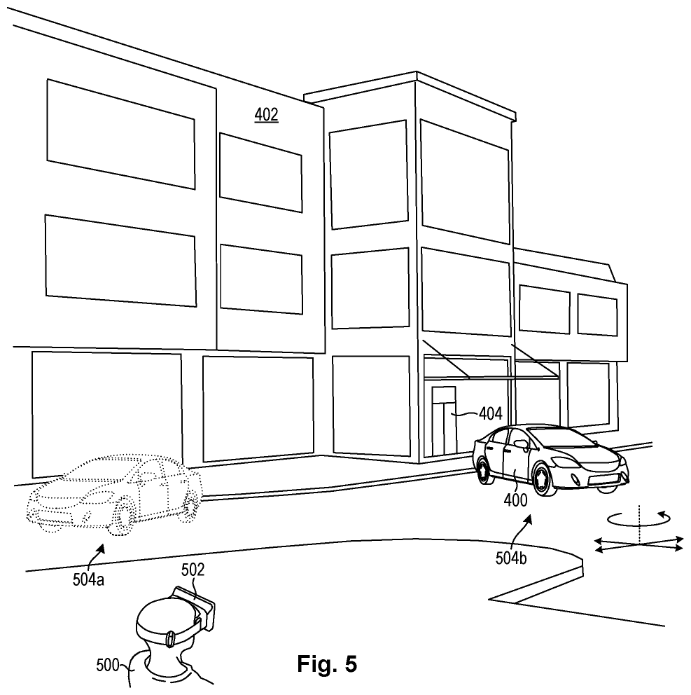

For example, as shown in FIG. 5, if the customer 500 wishes to back up the vehicle 400 to a point at or near the door of a building 402 to facilitate loading passengers and/or luggage, the customer 500 may move, within the augmented reality device 502, the 3-D model of the vehicle 400 to a desired position in front of the building 402. Moving may include orienting (e.g., rotating) the 3-D model in a desired direction and/or linearly translating the 3-D model until the vehicle 400 reaches a desired position in the surrounding environment within the augmented reality device 502. FIG. 5 shows what the 3-D model of the vehicle 400 may look like after the customer 500 has moved the vehicle 400 from a position 504a, such as that shown in FIG. 4, to a desired position 504b in the surrounding environment.

Once the 3-D model of the vehicle 400 is placed on the backdrop in a desired position, the position may be communicated 306 to the ride-hailing service. At this point, the method 200 and more specifically the ride-hailing service may determine 308 whether the vehicle 400 can actually be placed at the position indicated by the customer 500. This may be accomplished, for example, by scanning the surrounding environment to determine if the customer's designated placement is possible. If the position is not possible, the method 200 may calculate 310 the nearest possible position of the vehicle 400 and adjust the position of the vehicle 400 accordingly. In certain embodiments, this new or adjusted position may be shown to the customer 500 on the augmented reality device.

Once the position is communicated to the ride-hailing service, the position may be relayed 216 to the vehicle 400, and more particularly to the driver of the vehicle 400. Alternatively, the position may be communicated 216 directly to the vehicle 400 or driver of the vehicle 400 from the customer 500. In certain embodiments, the driver may be shown a picture of the vehicle 400 (i.e., a 3-D model of the vehicle 400) relative to the surrounding real-world environment so that the driver knows where and how to place the vehicle 400. This may enable the driver to place the vehicle 400 at the position selected by the customer upon arriving at the designated pickup spot.

At this point, the method 200 may end. However, if multiple vehicles 400 are involved, the method 200 may proceed to the steps illustrated in FIG. 3. As shown in FIG. 3, if multiple vehicles 400 are involved, the method 200 may identify 300 the number of vehicles 400 as well as the available space at the designated pickup spot. The method 200 also provide 302 3-D models of the vehicles 400 for use with augmented reality device(s) 502. The method 200 enables 304 customer(s) 500 to manipulate the 3-D models in augmented reality in order to designate positions (e.g., orientations, locations, etc.) of the vehicles 400 and relative placement of the vehicles 400 at the designated pickup spot within the surrounding environment.

These positions may be communicated 306 to the ride-hailing service. In certain embodiments, the ride-hailing service may determine 308 if the vehicles 400 can be placed at the designated positions. If placement at the designated positions is not possible (e.g., due to buildings, landscaping, roads, architectural elements, or other cars or objects that prevent placement at the designated positions etc.), the method 200 may calculate the nearest possible positions and readjust the positions from what was designated by the customer(s) 500. In certain embodiments, the newly adjusted positions may be shown to the customer(s) 500 on the augmented reality device(s) 502. Once the positions of the vehicles 400 are determined, the positions may be relayed 312 to the vehicles 400 or drivers of the vehicles 400. This may allow the drivers of the vehicles 400 to position the vehicles 400 at the designated pickup spot in the manner selected by the customer(s) 500, or at least in a way that optimizes the placement for the convenience of the customer(s) 500.

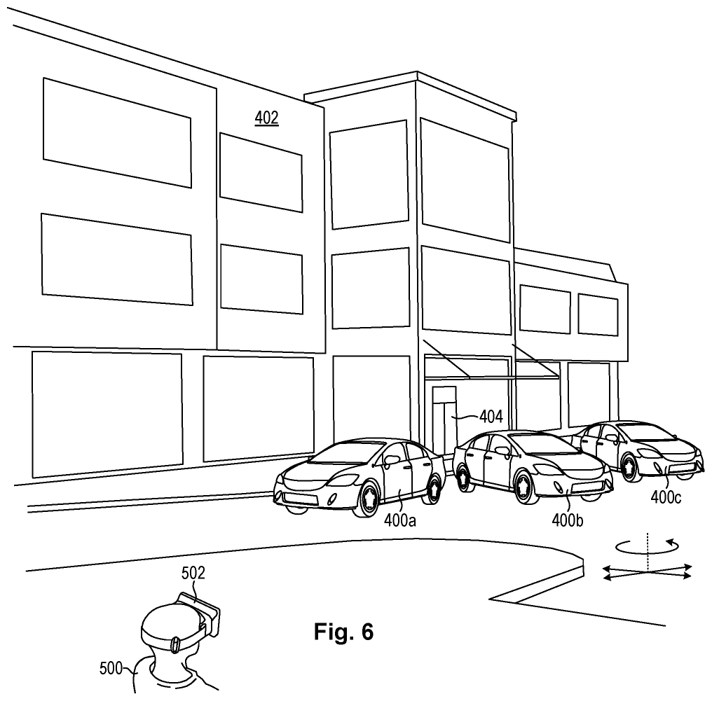

For example, as shown in FIG. 6, if three vehicles 400a-c are involved and customer(s) 500 wish to position and orient the vehicles 400a-c in the manner shown in FIG. 6, the customer(s) 500 may manipulate 3-D models of the vehicles 400a-c in augmented reality device(s) 502 until they reflect desired positions within the surrounding environment. Once these positions are established in the augmented reality device(s) 502, the positions may be relayed to the ride-hailing service for eventual communication to the vehicles 400 and/or drivers thereof. Alternatively, the positions may be relayed directly from the customer(s) 500 to the vehicles 400 and/or drivers thereof.

In the event the multiple vehicles 400a-c are associated with different customers 500 and the multiple vehicles 400a-c are scheduled to arrive at the designated pickup spot at the same or overlapping times, systems and methods in accordance with the invention may enable the customers 500 to collaborate or communicate with one another so that the vehicles 400 interfere with each other as little as possible. In certain embodiments, the augmented reality device 502 of one customer 500 may show not only the customer's vehicle 400 but also the vehicles 400 of other customers 500 that may have overlapping schedules with the customer's schedule. This may allow the customer 500 to avoid interfering with other customer's vehicles 400. This avoidance may be accomplished manually by the customer 500 or automatically from the ride-hailing service.

In addition to assisting customers 500 in positioning vehicles 400 arriving at designated pickup spots, augmented reality devices 502 may provide additional features and functions. For example, when positioning a vehicle 400, an augmented reality device 502 may show, based on the positioning, how passengers and/or luggage are most efficiently loaded into the vehicle 400. This may assist a customer 500 in preparing for the arrival of the vehicle 400. In other embodiments, once the vehicle 400 is positioned, the augmented reality device 502 may show safety zones or boundaries to a customer 500 to assist the customer 500 is safely boarding the vehicle 400 or loading cargo in to the vehicle 400, such as on a busy street. Other functions and features of augmented reality devices 502 are possible and within the scope of the invention.

The disclosed systems and methods provide greater utility and optimization to ride-hailing services when picking up a customer. For example, using the disclosed systems and methods, a vehicle that arrives in response to a request may be located or oriented in a way that is safer and more convenient for a customer to get into the vehicle and/or load baggage or other items into the vehicle. If a customer is disabled, an arriving vehicle may be more conveniently oriented or positioned to accommodate the customer's disability. This can make catching a ride with a ride-hailing service easier, safer, and more convenient.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other implementations may not require all of the disclosed steps to achieve the desired functionality. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

Several examples will now be provided to further clarify various aspects of the present disclosure:
Example 1: A method for utilizing augmented reality for positioning vehicles includes enabling a user to visualize, by way of an augmented reality device, a desired position of a vehicle selected to arrive at a designated pickup spot. The method documents the desired position and communicates the desired position to a ride-hailing service to enable the vehicle to be placed in accordance with the desired position upon arriving at the designated pickup spot.
Example 2: The limitations of Example 1, wherein the desired position includes at least one of a location and orientation of the vehicle.
Example 3: The limitations of any of Examples 1-2, wherein visualizing the desired position comprises visualizing the desired position within an environment surrounding the pickup spot.
Example 4: The limitations of any of Examples 1-3, wherein the desired position is selected to optimize loading passengers into the vehicle at the designated pickup spot.
Example 5: The limitations of any of Examples 1-4, wherein the desired position is selected to optimize loading cargo into the vehicle at the designated pickup spot.
Example 6: The limitations of any of Examples 1-5, wherein visualizing the desired position comprises visualizing the desired position of a specific make and model of the vehicle.
Example 7: The limitations of any of Examples 1-6, wherein visualizing the desired position comprises visualizing the desired position at or near a time of booking the vehicle.
Example 8: A computer program product comprising one or more computer readable storage media, and program instructions collectively stored on the one or more computer readable storage media, the program instructions comprising instructions configured to cause one or more processors to perform a method according to any one of Examples 1-7.
Example 9: A system comprising one or more processor and one or more computer-readable storage media collectively storing program instructions which, when executed by the processor, are configured to cause the processor to perform a method according to any of Examples 1-7.

1. A method for utilizing augmented reality for positioning vehicles, the method comprising:
enabling a user to visualize, by way of an augmented reality device, a desired position of a vehicle selected to arrive at a designated pickup spot;
documenting the desired position; and
communicating the desired position to a ride-hailing service to enable the vehicle to be placed in accordance with the desired position upon arriving at the designated pickup spot.

2. The method of claim 1, wherein the desired position includes at least one of a location and orientation of the vehicle.

3. The method of claim 1, wherein visualizing the desired position comprises visualizing the desired position within an environment surrounding the pickup spot.

4. The method of claim 1, wherein the desired position is selected to optimize loading passengers into the vehicle at the designated pickup spot.

5. The method of claim 1, wherein the desired position is selected to optimize loading cargo into the vehicle at the designated pickup spot.

6. The method of claim 1, wherein visualizing the desired position comprises visualizing the desired position of a specific make and model of the vehicle.

7. The method of claim 1, wherein visualizing the desired position comprises visualizing the desired position at or near a time of booking the vehicle.

8. A computer program product for utilizing augmented reality for positioning vehicles, the computer program product comprising a computer-readable storage medium having computer-usable program code embodied therein, the computer-usable program code configured to perform the following when executed by at least one processor:
enable a user to visualize, by way of an augmented reality device, a desired position of a vehicle selected to arrive at a designated pickup spot;
document the desired position; and
communicate the desired position to a ride-hailing service to enable the vehicle to be placed in accordance with the desired position upon arriving at the designated pickup spot.

9. The computer program product of claim 8, wherein the desired position includes at least one of a location and orientation of the vehicle.

10. The computer program product of claim 8, wherein visualizing the desired position comprises visualizing the desired position within an environment surrounding the pickup spot.

11. The computer program product of claim 8, wherein the desired position is selected to optimize loading passengers into the vehicle at the designated pickup spot.

12. The computer program product of claim 8, wherein the desired position is selected to optimize loading cargo into the vehicle at the designated pickup spot.

13. The computer program product of claim 8, wherein visualizing the desired position comprises visualizing the desired position of a specific make and model of the vehicle.

14. The computer program product of claim 8, wherein visualizing the desired position comprises visualizing the desired position at or near a time of booking the vehicle.

15. A system for utilizing augmented reality for positioning vehicles, the system comprising:
at least one processor;
at least one memory device operably coupled to the at least one processor and storing instructions for execution on the at least one processor, the instructions causing the at least one processor to:
enable a user to visualize, by way of an augmented reality device, a desired position of a vehicle selected to arrive at a designated pickup spot;
document the desired position; and
communicate the desired position to a ride-hailing service to enable the vehicle to be placed in accordance with the desired position upon arriving at the designated pickup spot.

16. The system of claim 15, wherein the desired position includes at least one of a location and orientation of the vehicle.

17. The system of claim 15, wherein visualizing the desired position comprises visualizing the desired position within an environment surrounding the pickup spot.

18. The system of claim 15, wherein the desired position is selected to optimize loading passengers into the vehicle at the designated pickup spot

19. The system of claim 15, wherein the desired position is selected to optimize loading cargo into the vehicle at the designated pickup spot.

20. The system of claim 15, wherein visualizing the desired position comprises visualizing the desired position of a specific make and model of the vehicle.
